(19) United States
(12) Patent Application Publication
(10) Pub. No.: US 2017/0139281 A1
(43) Pub. Date: May 18, 2017

(54) ALIGNMENT METHOD OF FFS TYPE LIQUID CRYSTAL PANEL

(71) Applicants: Shenzhen China Star Optoelectronics Technology Co., Ltd., Shenzhen City (CN); Wuhan China Star Optoelectronics Technology Co., Ltd., Wuhan City (CN)

(72) Inventors: Jun Hou, Shenzhen City (CN); Kaineng Yang, Shenzhen City (CN)

(21) Appl. No.: 14/777,745

(22) PCT Filed: Aug. 24, 2015
(86) PCT No.: PCT/CN2015/087913

§ 371 Date: Sep. 17, 2015

(30) Foreign Application Priority Data
Aug. 10, 2015 (CN) 201510485901.9

(51) Int. Cl. G02F 1/1337; G02F 1/1368; G02F 1/1335; G02F 1/1341

(52) U.S. Cl. CPC G02F 1/133788; G02F 1/133711; G02F 1/1341; G02F 1/1368; G02F 1/133514; G02F 1/133516; G02F 2202/023; G02F 2001/13415

(57) ABSTRACT

The present invention provides an alignment method of a FFS type liquid crystal panel. By irradiating the mixture of liquid crystal (10) and photosensitive small molecular compound (20′) with linearly polarized light to induce polymerization to the photosensitive small molecular compound (20′) to form high molecular polymer (20) with a specific direction to replace the traditional rubbing alignment for performing alignment to liquid crystal molecules (10), and utilizing torsional-energy of the aligned liquid crystal molecules (10), to irradiate rest of the photosensitive small molecular compound (20′) to completely react for performing alignment to liquid crystal molecules (10) once again, the electrification is not required in the entire alignment process, and the process difficulty is lower, and no alignment film bits remain in comparison with prior art. It can make the FFS type liquid crystal panel possess higher display contrast and raise the display quality.

### FIELD OF THE INVENTION

The present invention relates to a liquid crystal display technology field, and more particularly to an alignment method of a FFS type liquid crystal panel.

### BACKGROUND OF THE INVENTION

The LCD (Liquid Crystal Display) possesses many advantages of being ultra thin, power saved and radiation free. It has been widely utilized in, such as LCD TVs, smart phones, digital cameras, notebooks, flat panel PCs, public display devices, car display devices, and the liquid crystal display has already lived with the modern age inseparable.

The liquid crystal display in the present market generally comprises a shell, a LCD panel located in the shell and a backlight module located in the shell. The liquid crystal panel mainly comprises a Color Filter (CF), a Thin Film Transistor Array Substrate (TFT Array Substrate) and a Liquid Crystal Layer positioned inbetween. The working principle is that the light of backlight module is reflected to generate images by applying driving voltages to the two glass substrate for controlling the rotations of the liquid crystal molecules. According to the orientation of the liquid crystal, the liquid crystal panels in the mainstream market can be categorized into several types, which are Vertical Alignment (VA), Twisted Nematic (TN) or Super Twisted Nematic (STN), In-Plane Switching (IPS) and Fringe Field Switching (FFS).

For aligning the liquid crystal molecules more regularly, the Polyimide (PI) alignment films are respectively provided to the one sides of the Array Substrate and the Color Filter, which are closer to the liquid crystal layer in the traditional liquid crystal panel, and Rubbing alignment method is employed to perform alignment to the liquid crystal molecules. As shown from FIG. 1 to FIG. 3, first in the rubbing alignment method, one cloth roller 10 is used to rub trenches aligned according to a certain direction at the upper layer of the alignment film 30, and the deionized water is utilized to clean the surface of the alignment film 30, and finally, the liquid crystal panel lamination process is executed, and the liquid crystal molecules 50 are aligned along the direction of the trenches on the alignment film 30. Such traditional rubbing alignment method is simple and easy for operation, and the anchoring force is strong. However, the contrast of the display image is not high, and no guarantee of no remained alignment film bits can be got by using the deionized water to clean the surface of the alignment film 30, and the issues of broken light spots can easily happen as showing images.

With the development and revolution of the display technology, the demands of the people to the display image of the liquid crystal display have constantly raised. Therefore, the alignment method of the liquid crystal panel has to be improved.

### SUMMARY OF THE INVENTION

An objective of the present invention is to provide an alignment method of a FFS type liquid crystal panel, or which the process difficulty is lower and no alignment film bits remain in comparison with prior art. It can make the FFS type liquid crystal panel possess higher display contrast and raise the display quality.

For realizing the aforesaid objective, the present invention provides an alignment method of a FFS type liquid crystal panel, at least comprises steps of:

step 1, providing a TFT substrate and a CF substrate, and oppositely laminating the TFT substrate and the CF substrate, and dropping mixture of liquid crystal and photosensitive small molecular compound between the TFT substrate and the CF substrate to form a liquid crystal panel;

step 2, irradiating the liquid crystal panel with linearly polarized light to induce polymerization to the photosensitive small molecular compound to form high molecular polymer with a specific direction for performing initial alignment to liquid crystal molecules;

step 3, standing the liquid crystal panel.

The alignment method of FFS type liquid crystal panel further comprises:

step 4, irradiating the liquid crystal panel with linearly polarized light again to make rest of the photosensitive small molecular compound completely react for performing alignment to liquid crystal molecules once again.

The linearly polarized light is UV light.

The photosensitive small molecular compound is:

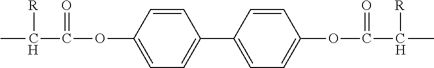

wherein R is an alkyl chain.

In the mixture of the liquid crystal and the photosensitive small molecular compound of the step 1, a weight percentage of the photosensitive small molecular compound and the liquid crystal is 0.1-3%.

Irradiation energy of the linearly polarized light in the step 2 is 1000-30000 mj, and an irradiation period is 60-300 seconds.

In the step 3, a duration of standing the liquid crystal panel is 30 min.

Irradiation energy of the linearly polarized light in the step 4 is 1000-30000 mj, and an irradiation period is 60-300 seconds.

The present invention further provides an alignment method of a FFS type liquid crystal panel, at least comprises steps of:

step 1, providing a TFT substrate and a CF substrate, and oppositely laminating the TFT substrate and the CF substrate, and dropping mixture of liquid crystal and photosensitive small molecular compound between the TFT substrate and the CF substrate to form a liquid crystal panel;

step 2, irradiating the liquid crystal panel with linearly polarized light to induce polymerization to the photosensitive small molecular compound to form high molecular polymer with a specific direction for performing initial alignment to liquid crystal molecules;

step 3, standing the liquid crystal panel;

the method further comprises:

step 4, irradiating the liquid crystal panel with linearly polarized light again to make rest of the photosensitive small molecular compound completely react for performing alignment to liquid crystal molecules once again;

wherein in the mixture of the liquid crystal and the photosensitive small molecular compound of the step 1, a weight percentage of the photosensitive small molecular compound and the liquid crystal is 0.1-3%;

wherein irradiation energy of the linearly polarized light in the step 2 is 1000-30000 mj, and an irradiation period is 60-300 seconds;

wherein in the step 3, a duration of standing the liquid crystal panel is 30 min;

wherein irradiation energy of the linearly polarized light in the step 4 is 1000-30000 mj, and an irradiation period is 60-300 seconds.

The benefits of the present invention are: the present invention provides an alignment method of a FFS type liquid crystal panel. By irradiating the mixture of liquid crystal and photosensitive small molecular compound with linearly polarized light to induce polymerization to the photosensitive small molecular compound to form high molecular polymer with a specific direction to replace the traditional rubbing alignment for performing alignment to liquid crystal molecules, and utilizing torsional-energy of the aligned liquid crystal molecules to irradiate rest of photosensitive small molecular compound to completely react for performing alignment to liquid crystal molecules once again, the electrification is not required in the entire alignment process, and the process difficulty is lower, and no alignment film bits remain in comparison with prior art. It can make the FFS type liquid crystal panel possess higher display contrast and raise the display quality.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 to FIG. 3 are diagrams of rubbing alignment according to prior art;

FIG. 4 is a flowchart of an alignment method of a FFS type liquid crystal panel according to the present invention;

FIG. 5 is a diagram of step 1 of an alignment method of a FFS type liquid crystal panel according to the present invention;

FIG. 6, FIG. 7 are diagrams of step 2 of an alignment method of a FFS type liquid crystal panel according to the present invention;

FIG. 8, FIG. 9 are diagrams of step 4 of an alignment method of a FFS type liquid crystal panel according to the present invention.

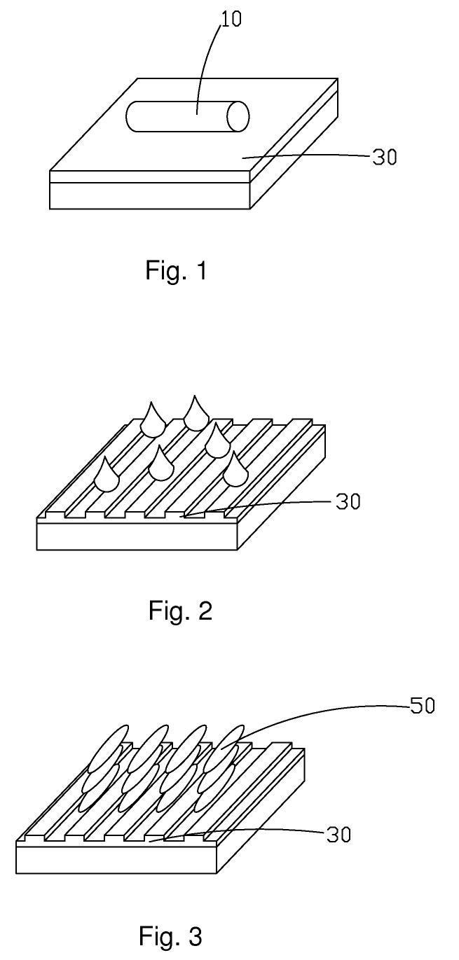

### DETAILED DESCRIPTION OF PREFERRED EMBODIMENTS

For better explaining the technical solution and the effect of the present invention, the present invention will be further described in detail with the accompanying drawings and the specific embodiments.

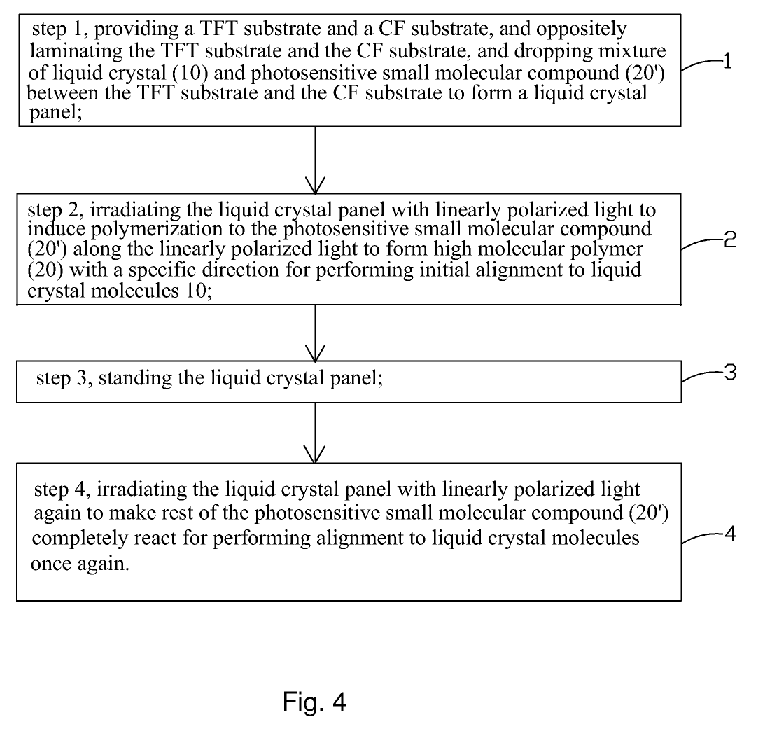

Please refer to FIG. 4. The present invention provides an alignment method of a FFS type liquid crystal panel, at least comprises steps of:

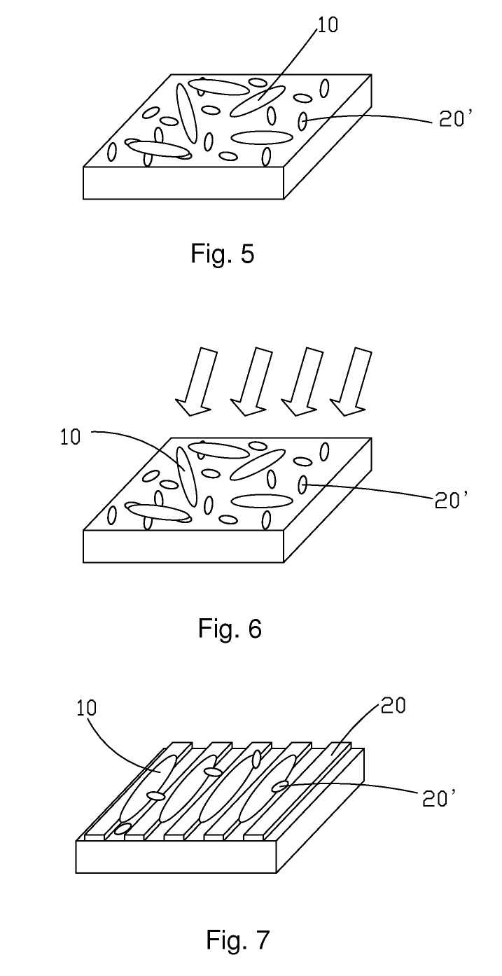

step 1, referring to FIG. 5, providing a TFT substrate and a CF substrate, and oppositely laminating the TFT substrate and the CF substrate (not shown), and dropping mixture of liquid crystal 10 and photosensitive small molecular compound 20′ between the TFT substrate and the CF substrate to form a liquid crystal panel.

In the step 1, The TFT substrate and the CF substrate do not only require the PI alignment film but other structures are also the same as the TFT substrate and the CF substrate according to prior art. The detail description is omitted here.

Specifically, in the mixture of the liquid crystal 10 and the photosensitive small molecular compound 20′, a weight percentage of the photosensitive small molecular compound 20′ and the liquid crystal 10 is 0.1-3%.

The photosensitive small molecular compound 20′ can be:

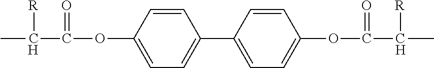

wherein R is an alkyl chain.

step 2, referring to FIG. 6, FIG. 7, irradiating the liquid crystal panel with linearly polarized light to induce polymerization to the photosensitive small molecular compound 20′ along the linearly polarized light to form high molecular polymer 20 with a specific direction to replace the traditional rubbing alignment film for performing initial alignment to liquid crystal molecules 10.

Preferably, the linearly polarized light is UV light.

In the step 2, irradiation energy of the linearly polarized light is 1000-30000 mj; an irradiation period is related with irradiation light intensity, which is 60-300 seconds in general.

After the step 2 is accomplished, polymerization occurs to most of the photosensitive small molecular compound 20′ to achieve the alignment result.

step 3, standing the liquid crystal panel.

Preferably, in the step 3, a duration of standing the liquid crystal panel is 30 min.

Then, small amount of not reacted photosensitive small molecular compound 20′ still remains in the liquid crystal panel, which will directly influence the image display quality of the liquid crystal panel if not treatment is performed. For eliminating the influence of the small amount of not reacted photosensitive small molecular compound 20′ which remains, the alignment method of the liquid crystal panel according to the present invention further comprises:

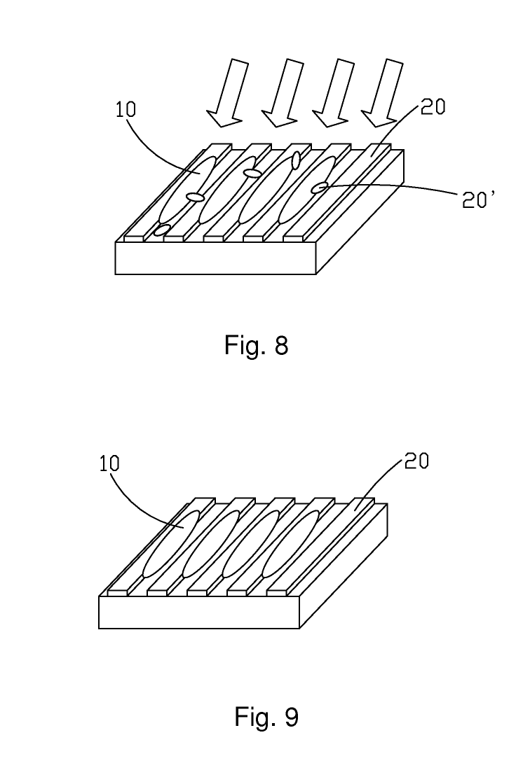

step 4, referring to FIG. 8, FIG. 9, irradiating the liquid crystal panel with linearly polarized light again to make rest of the photosensitive small molecular compound 20′ completely react, and because the liquid crystal molecules 10 with a specific direction close to the high molecular polymer 20 formed in the aforesaid step 2 have already been aligned, the torsional-energy of the liquid crystal molecules 10 is employed to make the rest of the photosensitive small molecular compound 20′ completely react for performing alignment to liquid crystal molecules once again.

Preferably, in the step 4, irradiation energy of the linearly polarized light is 1000-30000 mj; an irradiation period is related with irradiation light intensity, which is 60-300 seconds in general.

After the step 4 is accomplished, no photosensitive small molecular compound 20′ remains, and the liquid crystal molecules 10 are regularly aligned along the alignment direction.

The electrification is not required in the entire alignment process of the alignment method of the liquid crystal panel according to the present invention, and the process difficulty is lower; with utilizing light alignment, no alignment film bits remain in comparison with prior art. It can make the liquid crystal panel possess higher display contrast and raise the display quality.

In conclusion, in the present invention provides an alignment method of a FFS type liquid crystal panel. by irradiating the mixture of liquid crystal and photosensitive small molecular compound with linearly polarized light to induce polymerization to the photosensitive small molecular compound to form high molecular polymer with a specific direction to replace the traditional rubbing alignment for performing alignment to liquid crystal molecules, and utilizing torsional-energy of the aligned liquid crystal molecules to irradiate rest of photosensitive small molecular compound to completely react for performing alignment to liquid crystal molecules once again, the electrification is not required in the entire alignment process, and the process difficulty is lower, and no alignment film bits remain in comparison with prior art. It can make the FFS type liquid crystal panel possess higher display contrast and raise the display quality.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An alignment method of a FFS type liquid crystal panel, at least comprises steps of:
step 1, providing a TFT substrate and a CF substrate, and oppositely laminating the TFT substrate and the CF substrate, and dropping mixture of liquid crystal and photosensitive small molecular compound between the TFT substrate and the CF substrate to form a liquid crystal panel;
step 2, irradiating the liquid crystal panel with linearly polarized light to induce polymerization to the photosensitive small molecular compound to form high molecular polymer with a specific direction for performing initial alignment to liquid crystal molecules;
step 3, standing the liquid crystal panel.

2. The alignment method of the FFS type liquid crystal panel according to claim 1, further comprising:
step 4, irradiating the liquid crystal panel with linearly polarized light again to make rest of the photosensitive small molecular compound completely react for performing alignment to liquid crystal molecules once again.

3. The alignment method of the FFS type liquid crystal panel according to claim 1, wherein the linearly polarized light is UV light.

4. The alignment method of the FFS type liquid crystal panel according to claim 2, wherein the linearly polarized light is UV light.

5. The alignment method of the FFS type liquid crystal panel according to claim 1, wherein the photosensitive small molecular compound is: 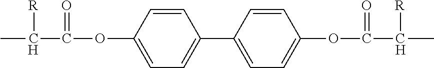
wherein R is an alkyl chain.

6. The alignment method of the FFS type liquid crystal panel according to claim 1, wherein in the mixture of the liquid crystal and the photosensitive small molecular compound of the step 1, a weight percentage of the photosensitive small molecular compound and the liquid crystal is 0.1-3%.

7. The alignment method of the FFS type liquid crystal panel according to claim 1, wherein irradiation energy of the linearly polarized light in the step 2 is 1000-30000 mj, and an irradiation period is 60-300 seconds.

8. The alignment method of the FFS type liquid crystal panel according to claim 1, wherein in the step 3, a duration of standing the liquid crystal panel is 30 min.

9. The alignment method of the FFS type liquid crystal panel according to claim 2, wherein irradiation energy of the linearly polarized light in the step 4 is 1000-30000 mj, and an irradiation period is 60-300 seconds.

10. An alignment method of a FFS type liquid crystal panel, at least comprises steps of:
step 1, providing a TFT substrate and a CF substrate, and oppositely laminating the TFT substrate and the CF substrate, and dropping mixture of liquid crystal and photosensitive small molecular compound between the TFT substrate and the CF substrate to form a liquid crystal panel;
step 2, irradiating the liquid crystal panel with linearly polarized light to induce polymerization to the photosensitive small molecular compound to form high molecular polymer with a specific direction for performing initial alignment to liquid crystal molecules;
step 3, standing the liquid crystal panel;
the method further comprises:
step 4, irradiating the liquid crystal panel with linearly polarized light again to make rest of the photosensitive small molecular compound completely react for performing alignment to liquid crystal molecules once again;
wherein in the mixture of the liquid crystal and the photosensitive small molecular compound of the step 1, a weight percentage of the photosensitive small molecular compound and the liquid crystal is 0.1-3%;
wherein irradiation energy of the linearly polarized light in the step 2 is 1000-30000 mj, and an irradiation period is 60-300 seconds;
wherein in the step 3, a duration of standing the liquid crystal panel is 30 min;
wherein irradiation energy of the linearly polarized light in the step 4 is 1000-30000 mj, and an irradiation period is 60-300 seconds.

11. The alignment method of the FFS type liquid crystal panel according to claim 10, wherein the linearly polarized light is UV light.

12. The alignment method of the FFS type liquid crystal panel according to claim 10, wherein the photosensitive small molecular compound is: 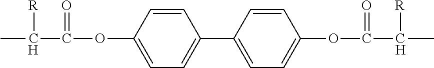
wherein R is an alkyl chain.
